(19) United States
(12) Patent Application Publication
(10) Pub. No.: US 2006/0157553 A1
(43) Pub. Date: Jul. 20, 2006

(54) ACCOMMODATING MULTIPLE USERS OF A SECURE CREDIT CARD

(75) Inventors: Edward E. Kelley, Wappingers Falls, NY (US); Franco Motika, Hopewell Junction, NY (US)

Correspondence Address: WHITHAM, CURTIS & CHRISTOFFERSON, P.C., 11491 SUNSET HILLS ROAD, SUITE 340, RESTON, VA, 20190, US

(73) Assignee: INTERNATIONAL BUSINESS MACHINES CORPORATION, Armonk, NY (US)

(21) Appl. No.: 10/905,716

(22) Filed: Jan. 18, 2005

(51) Int. Cl. G06K 5/00; G06K 19/06; G06Q 40/00; G06Q 20/00

(52) U.S. Cl. 235/380; 235/492; 705/44; 705/18

(57) ABSTRACT

A secure credit card provides for secure transactions by users other than a holder of the secure credit card by providing storage for additional personal identification numbers (PINs) for authorized users. Transactions for authorized users may be controlled in accordance with individual user profiles stored in the secure credit card and which may be freely and flexibly established in regard to transaction amount, merchant restrictions and the like in response to recognition of a PIN corresponding to a holder of the secure credit card to whom the card is issued.

### BACKGOUND OF THE INVENTION

1. Field of the Invention

The present invention generally relates to so-called smart cards and, more particularly to alternative uses of highly secure credit cards as personal identification cards for controlling access to data, secured locations, machinery, personal or commercial articles, data processing equipment and the like.

2. Description of the Prior Art

Proliferation of fraudulent activities such as identity theft, often facilitated by streamlining of electronic financial transactions and the proliferation of credit and debit cards often used in such transactions, has led to great interest in techniques for improving security and authentication of the identity of a user of such credit and debit cards. Recent advances in semiconductor technology, particularly extremely thin substrates, has also allowed chips to be fabricated with substantial mechanical flexibility and robustness adequate for inclusion of electronic circuits of substantial complexity within conveniently carried cards physically similar to credit cards currently in use. Such technology has also allowed records of substantial information content to be similarly packaged and associated with various articles, animals or persons such as maintenance records for motor vehicles or medical records for humans or animals. In regard to increase of security for financial transactions however, various attempts to increase security through improved identity authentication or disablement in case of theft or other misuse, while large in number and frequently proposed have not, until recently, proven adequate for the purpose.

However, a highly secure credit or debit card design has been recently invented and is disclosed in U.S. Pat. No. 6,641,050 B2, issued Nov. 4, 2003, and assigned to the assignee of the present invention, the entire disclosure of which is hereby fully incorporated by reference for details of implementation thereof. In summary, the secure credit/debit card disclosed therein includes a keyboard or other selective data entry device, a free-running oscillator, an array of electronic fuses (e-fuses) or other non-volatile memory, a processor, a pair of linear feedback shift registers (LFSRs) and a transmitter/receiver to allow communication with an external card reader. The card is uniquely identified by a unique identification number and the programming of e-fuses which control feedback connections for each of the LFSRs, one of which is used as a reference and the other is used in the manner of a pseudo-random number generator. The card is activated only for short periods of time sufficient to complete a transaction by entry of a personal identification number (PIN) that can also be permanently programmed into the card. When the card is activated and read by a card reader, the two sequences of numbers generated by the LFSRs are synchronously generated and a portion thereof is communicated to a reader which not only authenticates the number sequences against each other and the card identification number but also rejects the portion of the sequence if it is the same portion used in a previous transaction to guard against capture of the sequences by another device. This system provides combined authentication of the holder/user and the card, itself, together with encryption of transaction information unique to each card which renders the card useless if stolen while providing highly effective protection against simulation and/or duplication of the card or capture of information from it and has proven highly effective in use.

However, since the secure credit card in accordance with the above-incorporated patent provides for authentication of the holder/user, it is basically inconsistent with some current preferred modes of use of a credit card such as allowing a spouse or child to possess and possibly use a particular credit card for emergency or other particular purposes. For example, regardless of the relationship between the holder (i.e. the person to whom the card is originally issued by a financial institution which normally maintains ownership of the card) of the card and a person the holder may wish to allow to use it, there may be a strong reluctance of the holder to reveal his own PIN number to such a person since, for example, the holder may use the same PIN number to control other accounts or access rights. Further, the holder of the card may have a relatively large line of credit and may wish to restrict the usage by another person to a much lower amount or a periodic total (e.g. number of dollars per month) commensurate with the contemplated or intended use or restrict use to certain merchants or service providers (hereinafter referred to collectively as merchants). If a card is to be regularly used by a number of persons such as employees of a business, the holder may wish to separately track usage by each person authorized to use the card. In any of these circumstances, even with the high level of security provided by the secure credit card, itself, it is desirable to have confirmation that each use is authorized.

### SUMMARY OF THE INVENTION

It is therefore an object of the present invention to provide a secure credit card similar to that disclosed in U.S. Pat. No. 6,641,050, but accommodating a plurality of freely assignable PIN numbers which may be associated with authorized user profiles to control privileges of individual authorized users and identify their transactions using the secure credit card.

In order to accomplish these and other objects of the invention, a method of regulating privileges permitted using a secure credit card is provided comprising steps of providing a personal identification number (PIN) for a user in addition to a PIN identifying a holder of the secure credit card, associating a profile corresponding to the PIN provided for the user, and accessing the profile when the secure credit card is activated using the PIN provided for the user.

In accordance with another aspect of the invention, a secure credit card and secure financial transaction system is provided comprising a card body including a processor and associated storage for a stored program for operation of the processor, a communication interface, and a data entry arrangement, a non-volatile memory for storage of identification information for the secure credit card, a personal identification number (PIN) of a holder of said secure credit card and a PIN of at least one authorized user of the secure credit card, and encryption means for encoding transaction information and secure transaction codes in accordance with signals stored in the non-volatile memory, and an arrangement for distinguishing between the PIN of the holder and a PIN of an authorized user. The system usable with the secure credit card further comprises a card reader communicating with a server controlled by an issuer of the secure credit card, and an arrangement for receiving transaction information and secure transaction codes from the secure credit card and accepting or rejecting a transaction responsive to the transaction information and secure transaction codes.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1, 2 and 3 are a flow chart illustrating operation and use of the invention,

FIG. 2A is an alternative portion of the flow chart of FIGS. 1-3,

FIG. 4 is an exemplary profile table used in the invention, and

FIGS. 5, 6A, 6B, 6C and 6D illustrate the secure credit card of U.S. Pat. No. 6,641,050 with modifications in accordance with the present invention.

### DETAILED DESCRIPTION OF A PREFERRED EMBODIMENT OF THE INVENTION

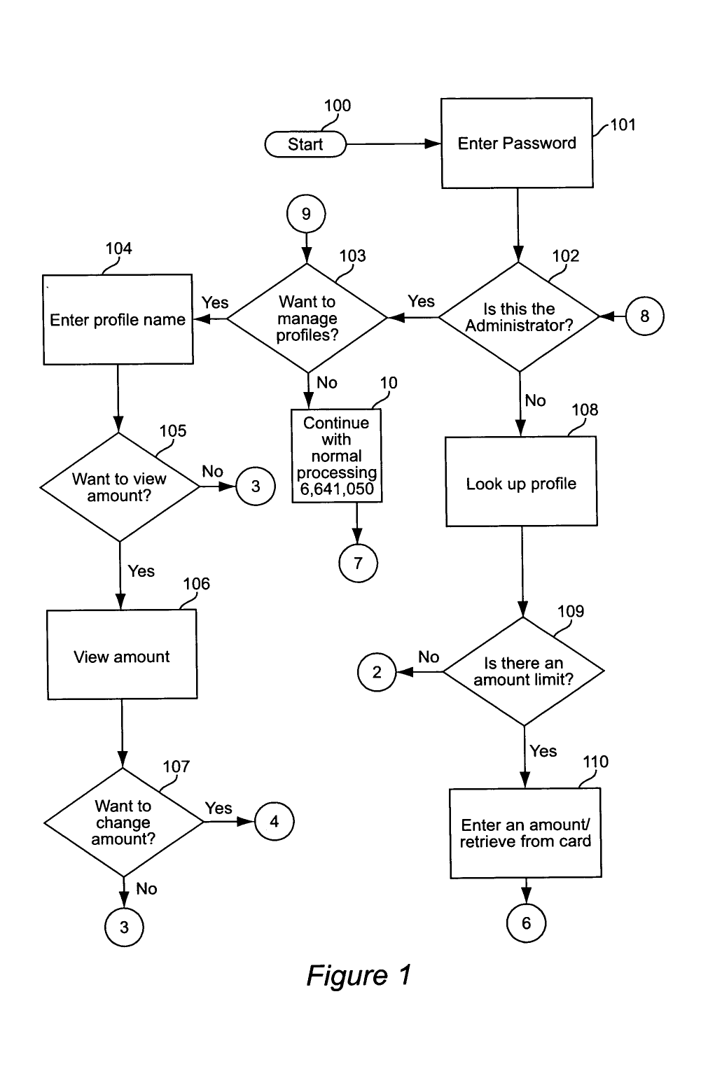

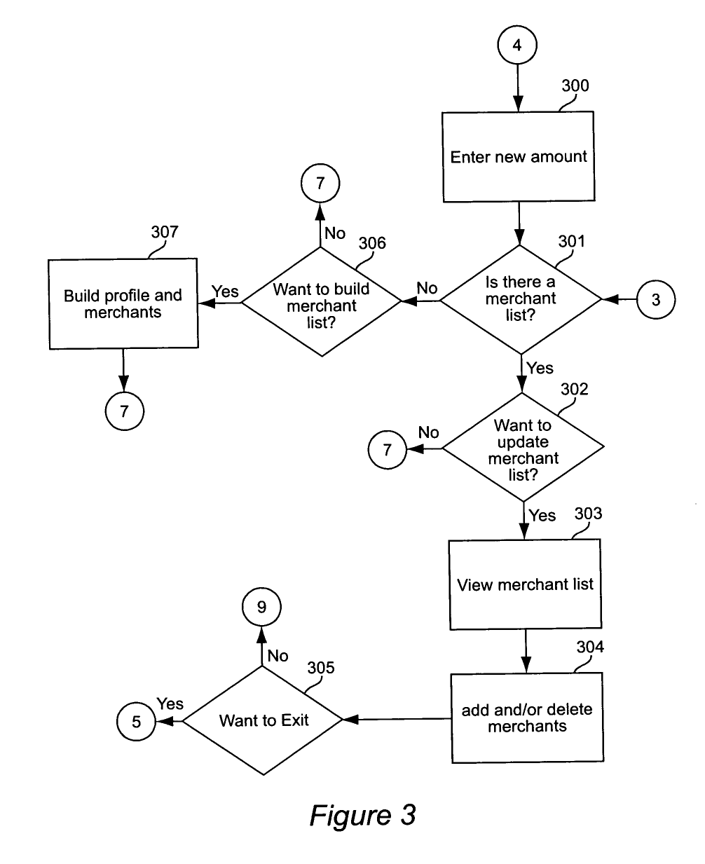

Referring now to the drawings, and more particularly to FIGS. 1-3, there is shown a flow chart illustrating an exemplary operation of the invention. This flow chart includes two basic sections: 1.) administration of authorized user PINs and profiles and 2.) determination of privileges of an authorized user during a transaction. As a matter of terminology hereinafter, the term Aholder@ will be used to refer to the person to whom a secure credit card is issued and Auser@ will be used to refer to an authorized user to whom the holder wishes to grant use privileges of the secure credit card. Considering the secure credit card and its capability to define and enforce user privileges as a system, the holder is, in essence, a system administrator having a unique authority in respect of the secure credit card to freely grant, remove and modify access rights and privileges for individual authorized users in the same way an administrator possesses authority to control access to resources of a computer system.

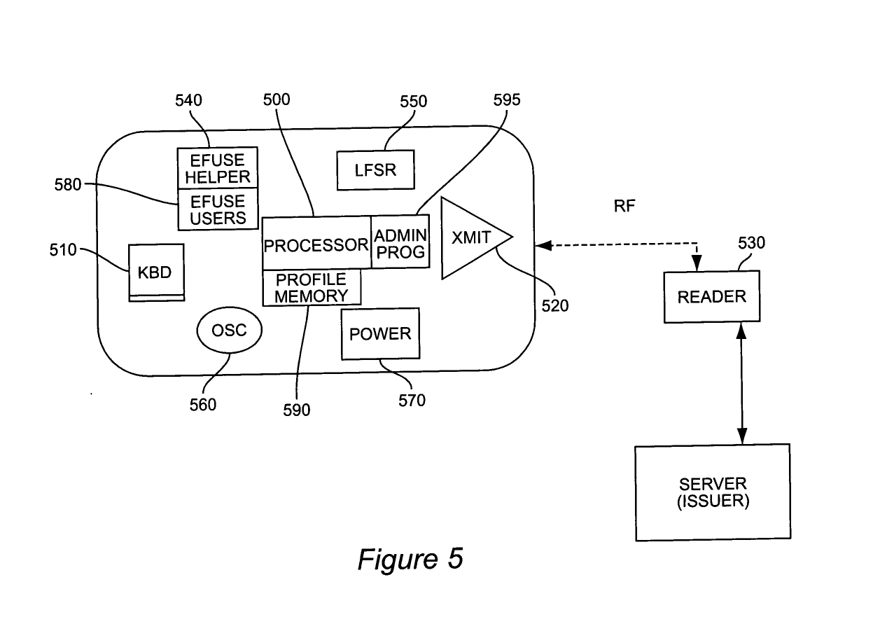

The operation of the multiple user secure credit card system in accordance with the invention starts (100) with entry of a PIN number or password 101 that initiates a session on the card processor 500 (FIG. 5) which includes additional storage 590 for user profiles and storage 595 for the program for administration of user PIN numbers and profiles and user transactions depicted in FIGS. 1-3. The secure credit card in accordance with the invention also includes additional e-fuse structure 580 similar to the e-fuse structure in the secure credit card of U.S. Pat. No. 6,641,050, but expanded to accommodate a desired number of user PIN numbers in addition to the PIN number of the holder illustrated at 540 of FIG. 5.

It may be useful to an understanding of the present invention to summarize the constitution and operation of the secure credit card disclosed in the above-incorporated U.S. Pat. No. 6,641,050. A smart card credit card as disclosed in this U.S. patent incorporates integrated electronics within it so that basic processing of information and transmission of information to and from the card may occur. In addition, this secure credit card also uses two linear feedback shift registers (LFSR) respectively referred to as a reference LFSR and a secure LFSR. These LFSRs are synchronized by common free running clock oscillator. The secure LFSR is customized to a unique configuration for each secure credit card. This combination of LFSRs is the key to generating a pseudo random binary string that is used to encrypt information. The generated binary string is a very large sequence sufficient for effective randomness. It is the state of the LFSRs, i.e., the binary sequences generated from the LFSRs and the card ID, that is transmitted to the issuing financial institution during a transaction whereby the institution can validate the authenticity of the card and the transaction. It is the configuration of the secure LFSR that gives the special uniqueness to each secure credit card. This configuration is very difficult and perhaps impossible for thieves to replicate as it cannot be read from the card itself. None of the memory configurations can be read or obtained from outside the secure card.

Unique LFSR configurations are accomplished by employing e-fuse technology within the card. E-fuse technology permits special memory arrangements to be created when the card is manufactured or when the card is issued. E-fuse technology uses writeable integrated fuses that can be “burned” after the card is assembled which in turn provides the unique configurations of the LFSRs and the card ID. There is a personalized identification number (PIN number) also burned into the card which the holder/user must enter to activate the secure card during each transaction.

The institution that issues the card must maintain a record of every card configuration. Whenever a secure credit card is involved in a transaction, the card ID permits the financial institution to retrieve the configuration data for the secure card involved in the transaction. From this configuration information, and the pseudo random number string returned from the secure credit card at the time of the transaction, the card and transaction can be authenticated.

When a holder/user wants to use the secure card, a PIN number must be entered directly into the card. If the PIN matches a PIN burned on the card, the secure credit card is activated and a pseudo random sequence is generated which is communicated to the financial institution authenticating the transaction. It is the nature of this combination of features of the secure credit card that makes it unlikely that no two transactions of a secure card will have the same pseudo random number sequences communicated outside the card.

A functional diagram of the secure card with associated sub-components is shown in FIG. 5. The secure card includes the main processor or controller chip 500, one or more touch-sensitive numeric key pads 510, radio frequency (RF) or magnetic external coupling 520 and 530, an integrated personalization e-fuse structure 540, pseudo random code generation LFSR 550, a free running clock oscillator 560, and a power source 570. As noted above, the multiple user secure credit card in accordance with the present invention additionally includes additional e-fuse capacity 580 for user PINs and additional storage 590, 595 associated with processor 500 for the PIN administration programming and user profile information.

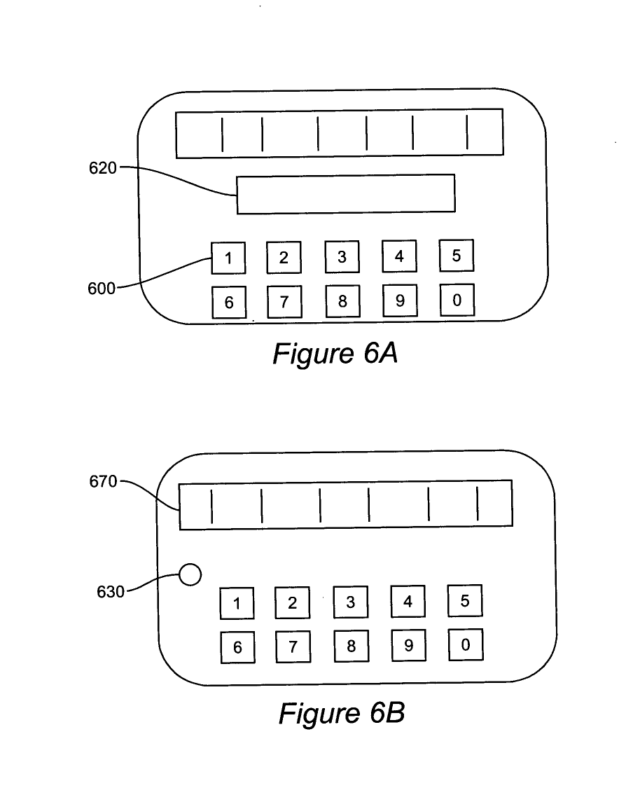

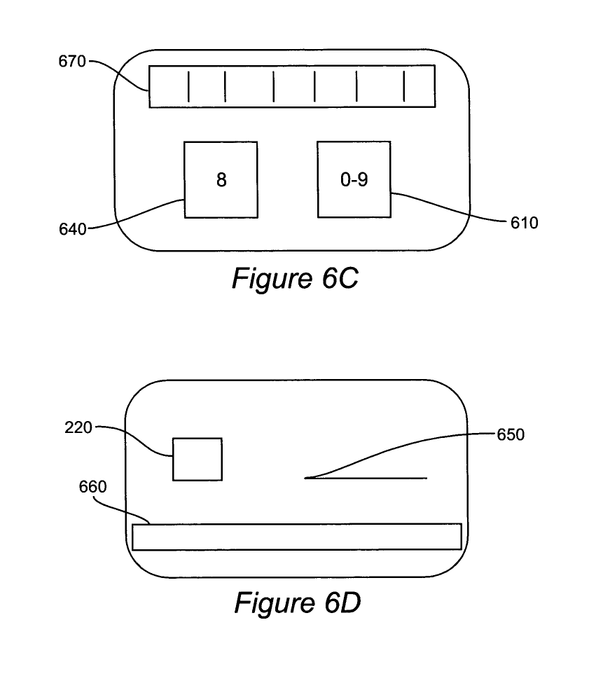

Referring now to FIGS. 6A, 6B, 6C and 6D, the physical secure credit card can take one of several alternative forms. The card shown in FIG. 6A has multiple digit key pad input 600, and a multiple character display 620 which works in conjunction with the input key pad. Since each card is personalized with a unique activation code at the time of issuance (e.g. the PIN of the holder and/or the holder=s administration access code which may be the same or different, as desired) and additional PINs for authorized users, the holder/user must input this code to enable the card before usage. The input key pad's main functions are to first power-on the dormant card by touching any of the key pads and second to provide a means to enter the activation code or PIN. The key pad may consist of either 0-9 numeric keys 600 as shown in FIG. 6A or a single “dynamic” key 610 as in FIG. 6C. Additional special keys (not shown) may be provided for alternate functions and future input extensions. These pads can be, for example, standard “touch-sensitive” capacitive keys.

The character display array 620 shown in FIG. 6A is intended to work in conjunction with the input key pad 600 and to provide card status information. The display function can be simplified by a single “enabled” status indicator 630 as shown in FIG. 6B. This status indicator would confirm the entry of the correct activation code from the key pad. It is also considered desirable to include a mode display which may be of any desired or convenient form to indicate the program branch for administration of PINs alluded to above. The display array may be implemented with liquid crystal elements or even LEDs if sufficient power is available.

The single key pad 610 and single character display 640 shown in FIG. 6C is intended to simplify the above hardware while still supporting the required input function. This is accomplished by dynamically cycling the display through a predefined character set. The cycling time would include a momentary delay to allow the user to depress the single key pad when the desired character is displayed. This input sequence is repeated until all the characters in their proper sequence are selected sequentially one at a time, such as the activation code character sequence. Once the activation code matches the internal personalization code, the display indicates the card status as enabled.

Returning now to FIGS. 1-3, it should be appreciated that the initial function of entry of the PIN, in addition to activating the card for a short period sufficient to perform a transaction, is to permit the card to distinguish between a holder and an authorized user. Of course, if the PIN which is entered does not match a registered PIN (e.g. as set in the e-fuse structure alluded to above) the secure credit card will revert to or remain in an inactive state. This latter function prevents excess power being consumed by powering up the card by inadvertent key actuation when the card is carried in a pocket, wallet or the like or in routine handling thereof when no transaction is intended. It may also be desirable to provide for permanent or extended period disablement of the card after a sequence of incorrect PIN number sequences (which may generally be distinguished from inadvertent key actuations by the number of keystrokes).

Once a registered PIN is recognized, it is determined at step 102 if the PIN corresponds to the holder or a user. This difference is preferably determined from the portion of the e-fuse or other PIN memory structure in which the matching PIN is found. Since a card will generally have only one holder, a unique, dedicated location is preferably provided for the PIN of the holder. If the PIN corresponds to a holder, the operation of the multi-user secure credit card branches to step 103 corresponding to the holders=s privileges of conducting a transaction as a holder with full privileges corresponding to the conditions of issuance of the card as described in the above-incorporated U.S. patent and/or the additional privilege in accordance with the present invention of functioning as an administrator for managing access, authorization and privileges of users. It is considered an important advantage of the present invention to accommodate administration by the holder and independently of the issuer, but those skilled in the art will appreciate that shared administration by the holder and the issuer may provide some additional security and/or flexibility of use in some circumstances.

While step 103 is depicted in FIG. 1 as a branching step, it should be recognized that it is also a call for holder input to indicate a choice between management of PINs and profiles or a normal transaction as the card holder as described in the above-incorporated U.S. patent. Assuming the former, the holder is prompted to enter a profile name (e.g. a name or pseudonym of an authorized user) at step 104. If a PIN has not been previously registered for a given authorized user, the holder should be prompted for a PIN, as well. In this regard, the holder may register a PIN of his own choosing and inform the user of the PIN which has been registered for the user or, since it is contemplated that an authorization will be established or edited in the presence of an potential user immediately prior to transfer of possession of the card between the holder and the user, the user may be permitted to input a PIN of his own choosing and which is unknown to the holder. To permit this flexibility of use, the holder is allowed to access the user profile and activate or deactivate the user=s PIN in accordance with the profile name rather than the user=s PIN while the user, having only his own PIN, cannot access the profile table at all since the administration portion of the system would only be entered following recognition of the PIN entered at 101 as the holder=s PIN. It is also considered preferable to provide for checking a newly entered PIN against PINs previously entered on the card since a unique PIN must be used in order to access a corresponding profile for the user as will be described below.

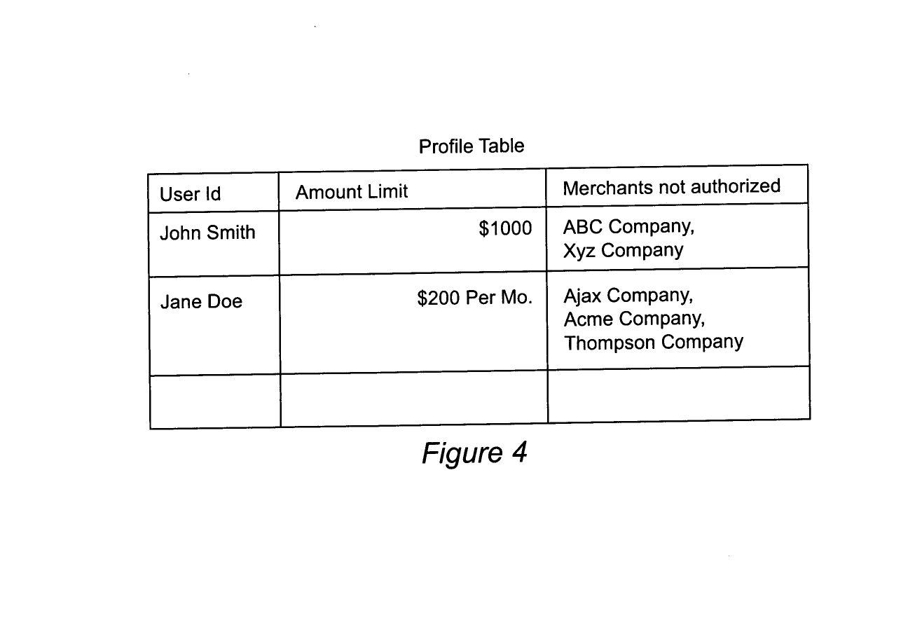

The steps following the entry 104 of a profile name provide for building or editing a profile for the authorized user. It should be noted that not all information which may be included in a profile need be provided and any omitted information will default to the holder=s privileges. However, it will generally be desired to enter some profile information to restrict the user=s privileges particularly when it is realized that granting full privileges of the holder other than for user profile administration reduces, however slightly, the security provided by the holder=s PIN. (That is, if full privileges of the card can be accessed from two PINs such as if the holder assigned an additional PIN number to himself (e.g. as a user), the possibility of an unauthorized person guessing a recognizable PIN, however small and which may be reduced by providing an increased number of digits of PINs, would be doubled. For the same reason, the number of users should be limited to a relatively small number relative to the number of possible PINs available and the profiles associated with additional PINs should be suitably restricted. However, the holder may wish to establish an additional PIN for himself as if he were a user in order to be alerted upon exceeding a monthly total or the like while allowing the holder to complete the transaction using his PIN as holder of the card with full privileges granted by the issuer.) Further, it should be recognized that, for illustrative purposes and enablement of practice of the invention, the user profile information is limited in this discussion and the illustration of FIGS. 1-3 to only the limit amount and unauthorized merchants, as shown in the exemplary profile table of FIG. 4 but that other information may be accommodated in other and/or additional fields and branching steps similar to those described and illustrated.

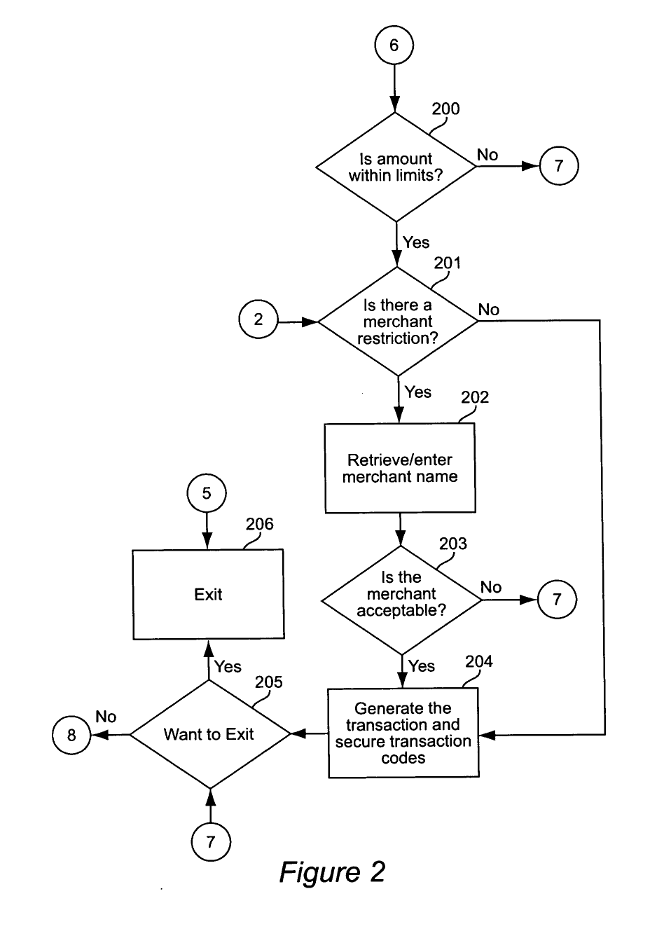

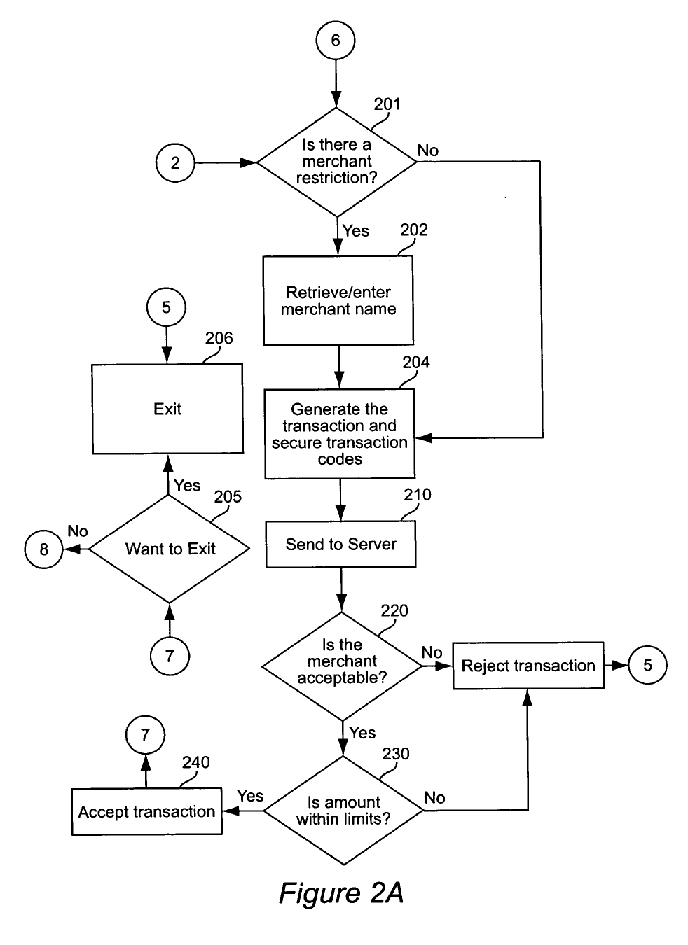

In the preferred sequence, the holder is first prompted to view or decline to view the amount specified in the user profile accessed by the profile name. If the holder declines to view the amount specified in the profile, the process branches to step 301 corresponding to processing of the next information field in the profile table; in this case, the merchant list. If the holder wishes to view the amount, the amount set in the profile table is displayed (106) and the holder is prompted at 107 to change the amount, if desired. If the amount is changed, the process branches to step 300 for entry of a new amount, after which the process proceeds with step 301 corresponding to the next profile information field, in this case, the merchant list. If no change is made, the process branches to step 301 directly, bypassing the step of entering a new amount. If step 301 determines that there is no merchant list entered for this particular profile, the user is prompted to build one, which, if declined (and no other profile fields are provided) the process branches to 205 of FIG. 2 where the holder (or user) may choose to exit and terminate (206) the session or not. If the holder decides to build a merchant list, step 307 provides for doing so by data entry in any convenient manner such as the keyboard manipulations described above and then allowing session termination at steps 205 and 206.

If a merchant list exists as determined at step 301, the holder is prompted to update it at step 302 which also provides branching to 205, 206 for potential session termination. If the merchant list is to be updated, the currently stored merchant list is displayed at step 303 and merchants may be added or deleted by keyboard entry or the like at step 304, after which the holder is again given the option of terminating the session at 305. It should be noted that step 305 differs from step 205 by the step specified for the ANo@ branch: step 305 allowing the process to remain in the user profile administration process which can be exited at 103 as discussed above, whereas step 205 maintains the process in the transaction and privilege determination process, allowing the holder to enter the user profile administration process at step 102.

If the holder does not wish to terminate the session, the process branches to step 103, described above, which allows the holder to build or edit another user profile, if desired, or, if not, to perform a normal transaction as the card holder as described in the above-incorporated U.S. patent, as indicated at step 10. It is considered preferable, in this regard, to provide for the transaction time begun when the card was activated by entry of the holder=s PIN to be suspended during user profile administration or, perhaps more simply, to be started on a choice not to manage user profiles at step 103.

If a user=s PIN is entered at step 101, as detected at step 102, the above process for management of user profiles will not be available and the process will branch from step 102 to step 108 where a user profile corresponding to the recognized PIN will be accessed. The following process steps will examine the fields of the user profile in turn and grant or deny privileges in regard to a transaction in accordance therewith. Some of these operations may be done in different ways, possibly in combination, as will be evident to those skilled in the art in light of the following discussion. Again, more, fewer and/or different fields may be provided in the profile than are discussed or illustrated here for purposes of conveying an understanding of the invention sufficient to its practice.

The presence on a transaction amount limit is determined at step 109 and, if none, the process defaults to the holder=s limit for amount and checks the next user profile field, in this case, for a merchant restriction at 201. If there is an amount limit, that limit is either retrieved from the card for the transaction or entered into the card at step 110 or both. That is, the comparison of the limit amount with the transaction amount may be performed in the card reader or server by retrieving the amount from the card and such processing external to the card may simplify processing on the card prior to authentication and completion of the transaction and/or reduce some hardware requirements on the card particularly in regard to cumulative amount limits such as a limit on expenditures per month. On the other hand, it would be more secure and thus may be considered preferable in some circumstances to avoid reading information from the card and enter the transaction amount information into the card where the comparison would then be performed as an incident of authenticating the transaction. In such a case, cumulative amount limits could be administered by decrementing the amount limit in the user profile as transactions are performed (e.g. over a given time period). The transaction amount is then compared and, if not within limits, the transaction is terminated and the user is prompted whether or not to exit the process as described above. If the transaction amount is within limits, a check for merchant restrictions is made at 201. If there is no merchant restriction in the user profile (which could be either positive, i.e. authorized merchants, or negative, i.e. restricted, unauthorized merchants or a combination thereof and either by specific merchants or collective categories thereof such as sellers of particular types of goods or services) the process branches to 204 to generate the secure transaction codes as disclosed in the above-incorporated U.S. patent in the same manner as for the holder (as depicted at 10 of FIG. 1) except that the user identity information will be included in the transaction information rather than that of the holder. This information is transmitted to the card reader 530 together with other card information security codes and the like as described in the above-incorporated U.S. patent.

If there is a merchant restriction, the merchant name is retrieved from the card (for external comparison or the name of the merchant to receive payment is entered into the card for internal comparison or both at step 202 is the same manner as described above in regard to the transaction amount. It should be appreciated that doing the comparison internally of the card for amount does not preclude the merchant name comparison from being performed externally to the card (as may be preferred) or vice-versa. In any case, a determination is made as to the acceptability of the merchant at step 203. As with the transaction amount, if the merchant is not acceptable, the option of exiting is provided at steps 205 and 206. Otherwise, the transaction is processed at step 204 and the option to exit is provided.

If the holder or user does not wish to exit the process, the process preferably branches to step 102 so that a holder may manage profiles subsequent to a transaction. This will allow a holder to, for example, generate a user profile for himself for another transaction to be separately tracked and reported or other useful functions which will become evident to those skilled in the art. It also allows another transaction time limit to be started for a holder or any user while preventing a user from accessing the profile management branch of the process. When the transaction is completed, if not earlier terminated, the holder/user may exit the process and deactivate the card or simply allow the transaction time to expire and automatically deactivate the multi-user secure credit card.

As either a variation of the invention or a perfecting feature thereof, the process illustrated in FIG. 2A may be substituted for the portion of the process described above which is illustrated in FIG. 2 or may be performed in addition to that process for additional security and/or authentication of a transaction. Essentially, the process of FIG. 2A provides for the ultimate acceptance of a transaction to be performed by the card issuer and may be useful, for example, where a holder may authorize a user to use a secure credit card as described above and a plurality of physical cards (or duplicate cards) may be issued for the same holder account to limit the number of authorized users of any given card and the card may be lost or stolen or the holder may wish to change or remove a user authorization or profile while the card is in the possession of the user and the desired authorization or profile change carried out through a separate communication (e.g. by telephone) to the issuer. The operation in accordance with FIG. 2A may also be useful in initial stages of implementation of a transaction system using the secure credit card in accordance with either the invention or the above-incorporated U.S. patent.

If the process of FIG. 2A is to be used as an alternative to the process of FIG. 2, after retrieving or entering the amount of the transaction (step 110 of FIG. 1) as described above, it is determined if there is a merchant restriction at 201 (rather than step 200 of FIG. 2. If so, the merchant name is entered or retrieved from the card in step 202 as described above. If not, step 202 is by6passed by branching and the process continues, in either case, with step 204 to generate the transaction and secure transaction codes as discussed above. As with the transaction amount, it is not necessary to perform a comparison of the merchant with the merchant restrictions (step 203 of FIG. 2) since both the amount and the merchant will be evaluated in the course of acceptance or rejection of the transaction at the server under control of the card issuer. Thus, to this point in FIG. 2A, the process is substantially the same as in FIG. 2 but omits comparisons 201, 203 for determining user privileges (e.g. at the point of sale, internally or externally of the card) and simply obtains the corresponding information for use in accepting or rejecting the transaction by the issuer at its server. On the other hand, if the secure process of FIG. 2 is to be supplemented by evaluation of the transaction by the issuer at its server for further authentication and/or control, all of steps 200-204 of FIG. 2 could be performed and the process of FIG. 2A entered at step 210 with the transaction information and secure transaction codes being sent to the server.

The transaction information and secure transaction codes are then evaluated at the server in steps 220 and 230 or others if additional information is provided and which can be performed in any order. If any of the transaction amount, merchant identification or other conditions (e.g. possibly including a mismatch of profile information between the card and information maintained by the issuer) are not acceptable to the issuer, the transaction is rejected and a message to that effect is returned to the card, causing direct exit 206 of the process described in regard to FIGS. 1-3. If all conditions specified by the profile (as maintained by the issuer) are acceptable, a message confirming acceptance of the transaction is sent to the card and the user/holder is given the option of exiting the process or continuing as described above.

In view of the foregoing, it is seen that the invention provides a secure credit card in which a high level of security may be maintained in regard to each of a plurality of users in addition to the holder and allows the holder to impose restrictions of any individual user=s use of the card and freely define and regulate the privileges which may be exercised using the card for each respective user.

While the invention has been described in terms of a single preferred embodiment, those skilled in the art will recognize that the invention can be practiced with modification within the spirit and scope of the appended claims.

What is claimed is:

1. A method of regulating privileges permitted using a secure credit card, said method comprising steps of
providing a personal identification number (PIN) for a user in addition to a PIN identifying a holder of said secure credit card,
associating a profile corresponding to said PIN provided for said user, and
accessing said profile when said secure credit card is activated using said PIN provided for said user.

2. A method as recited in claim 1, wherein said profile is defined by a holder of said secure credit card.

3. A method as recited in claim 2, wherein said profile includes at least one of a transaction amount restriction and a merchant restriction.

4. A method as recited in claim 1, including the further step of discriminating between a holder of said secure credit card and an authorized user of said secure credit card.

5. A method as recited in claim 1, including the further steps of identifying a holder of said secure credit card by entry of a PIN corresponding to said holder, and accessing a said user profile responsive to a profile name.

6. A method as recited in claim 1, including the further steps of
identifying a user of said secure credit card by entry of a PIN corresponding to said user, and
accessing a user profile corresponding to said PIN of said user.

7. A method as recited in claim 6, including the further step of
comparing a first information value in said user profile with transaction information, and
accepting or rejecting a transaction responsive to a result of said comparison step.

8. A method as recited in claim 7, wherein said first information value is a transaction amount limit.

9. A method as recited in claim 7, wherein said comparison step is performed internally of said secure credit card.

10. A method as recited in claim 7, wherein said comparison step is performed externally of said secure credit card.

11. A method as recited in claim 7 wherein said comparison step is performed in a server under control of an issuer of said secure credit card.

12. A method as recited in claim 7, including the further step of
comparing a second information value in said user profile with transaction information, and
accepting or rejecting a transaction responsive to a result of said step of comparing said second information value.

13. A method as recited in claim 12, wherein said second information value is a merchant restriction.

14. A method as recited in claim 12, wherein said step of comparing said second information value is performed internally of said secure credit card.

15. A method as recited in claim 12, wherein said step of comparing said second information value is performed externally of said secure credit card.

16. A method as recited in claim 12 wherein said step of comparing said second information value is performed in a server under control of an issuer of said secure credit card.

17. A method as recited in claim 5, including the further steps of
identifying a user of said secure credit card by entry of a PIN corresponding to said user, and
accessing a user profile corresponding to said PIN of said user.

18. A method as recited in claim 17, including the further step of
comparing a first information value in said user profile with transaction information, and
accepting or rejecting a transaction responsive to a result of said comparison step.

19. A method as recited in claim 17, wherein said first information value is a transaction amount limit.

20. A method as recited in claim 17, including the further step of
comparing a second information value in said user profile with transaction information, and
accepting or rejecting a transaction responsive to a result of said step of comparing said second information value.

21. A method as recited in claim 20, wherein said second information value is a merchant restriction.

22. A secure credit card comprising
a card body including a processor and associated storage for a stored program for operation of said processor, a communication interface, and a data entry means,
a non-volatile memory for storage of identification information for said secure credit card, a personal identification number (PIN) of a holder of said secure credit card and a PIN of at least one authorized user of said secure credit card, and
encryption means for encoding transaction information and secure transaction codes in accordance with signals stored in said non-volatile memory, and means for distinguishing between said PIN of said holder and a PIN of a said authorized user.

23. A secure credit card as recited in claim 22, wherein said non-volatile memory comprises an e-fuse structure.

24. A secure credit card as recited in claim 22, further including memory for storing a profile for each said authorized user of said secure credit card and wherein said program includes a program portion accessible in response to said PIN of said holder for establishing and storing a user profile for a said authorized user by a holder of said secure credit card identified in accordance with said PIN of said holder.

25. A secure credit card as recited in claim 24, wherein said program includes a program portion accessible by authorized users of said secure credit card in response to a PIN corresponding to an authorized user for accessing a said user profile corresponding to said PIN of said user.

26. A secure credit card as recited in claim 25, further including means for comparing transaction information with information stored in said user profile.

27. A secure credit card as recited in claim 26, wherein said information stored in said user profile includes a transaction amount limit.

28. A secure credit card as recited in claim 26, wherein said information stored in said user profile includes a merchant restriction.

29. A secure credit card as recited in claim 27, wherein said information stored in said user profile includes a merchant restriction.

30. A secure financial transaction system including
a secure credit card comprising
a card body including a processor and associated storage for a stored program for operation of said processor, a communication interface, and a data entry means
a non-volatile memory for storage of identification information for said secure credit card, a personal identification number (PIN) of a holder of said secure credit card and a PIN of at least one authorized user of said secure credit card,
encryption means for encoding transaction information and secure transaction codes in accordance with signals stored in said non-volatile memory, and means for distinguishing between said PIN of said holder and a PIN of a said authorized user,
a card reader communicating with a server controlled by an issuer of said secure credit card, and
means for receiving transaction information and secure transaction codes from said secure credit card and accepting or rejecting a transaction responsive to said transaction information and secure transaction codes.
